(19) United States
(12) Patent Application Publication
(10) Pub. No.: US 2014/0108045 A1
(43) Pub. Date: Apr. 17, 2014

(54) Epoch of Care-Centric Healthcare System

(71) Applicant: CLINICALBOX, INC., Waltham, MA (US)

(72) Inventors: Salim Afshar, Cambridge, MA (US); Farbod Hagigi, Watertown, MA (US); Murali Menon, Lexington, MA (US)

(73) Assignee: ClinicalBox, Inc., Waltham, MA (US)

(21) Appl. No.: 13/690,387

(22) Filed: Nov. 30, 2012

Related U.S. Application Data
(60) Provisional application No. 61/714,106, filed on Oct. 15, 2012.
(60) Provisional application No. 61/714,112, filed on Oct. 15, 2012.

(51) Int. Cl. G06F 19/00; G06Q 50/22

(52) U.S. Cl. CPC G06F 19/3437; G06Q 50/22
USPC 705/3

(57) ABSTRACT

A computer-based system and method improves the efficiency (quality and/or cost) of healthcare services provided to a patient by modeling an epoch of care (EOC) of the patient and by using the epoch of care model to assist in the provision of healthcare services to the patient, such as by generating predictions of healthcare outcomes for the patient and by making recommendations for actions to be taken in connection with the provision of healthcare services to the patient. An epoch of care of a patient may include all services (e.g., treatments, diagnoses, prognoses, tests, tasks, communications, education), products (e.g., medications, medical equipment, implants), and outcomes (e.g., readmissions, morbidities, patient satisfaction, symptoms) that are related to a particular medical condition or complaint of the patient over a period of time. Embodiments of the present invention may model multiple epochs of care for the same patient and may model epochs of care for multiple patients. Predictions and recommendations may be made based on the epoch of care data (including data relating to tests, treatments, and appointments spanning a wide range of times), possibly in addition to external data (e.g., contextual data, sensor data, medical history data) outside of the epoch of care.

### CROSS-REFERENCE TO RELATED APPLICATIONS

This application claims priority from the following patent applications, all of which are incorporated by reference herein:
U.S. Prov. Pat. App. Ser. No. 61/714,106, filed on Oct. 15, 2012, entitled, “Epoch of Care-Centric Healthcare System”;
U.S. Prov. Pat. App. Ser. No. 61/714,112, filed on Oct. 15, 2012, entitled, “Adaptive Medical Testing”; and
a concurrently-filed U.S. patent application entitled, “Adaptive Medical Testing” (Attorney Docket Number C0008-1002).

### BACKGROUND

A variety of technologies exist for helping healthcare professionals to make predictions about the outcomes of healthcare treatments and to assist healthcare professionals in making recommendations for such treatments. Although such technologies, in their simplest forms, date back to the earliest days of medicine, in recent years computer-based technologies have been used with increasing frequency to automate the formulation of predictions and recommendations.

Some existing technologies attempt to completely automate the generation of predictions and/or recommendations, while others seek to achieve the more modest goal of generating suggested predictions and/or recommendations for use as a starting point by human healthcare professionals. In either case, such existing technologies have a variety of drawbacks. For example, existing technologies typically are limited to making predictions and recommendations based solely on a particular patient's individual symptoms and history, and possibly based on generic information about other patients with the same symptoms or illness. As a result, the accuracy of the predictions and recommendations generated by such systems can suffer due to the limited information on which such predictions and recommendations are based.

What is needed, therefore, are improved systems for assisting in the provision of healthcare generally and, more specifically, improved systems for assisting in the generation and implementation of predictions and recommendations for use in the provision of healthcare services.

### SUMMARY

A computer-based system and method improves the efficiency (quality and/or cost) of healthcare services provided to a patient by modeling an epoch of care (EOC) of the patient and by using the epoch of care model to assist in the provision of healthcare services to the patient, such as by generating predictions of healthcare outcomes for the patient and by making recommendations for actions to be taken in connection with the provision of healthcare services to the patient. An epoch of care of a patient may include all services (e.g., treatments, diagnoses, prognoses, tests, tasks, communications, education), products (e.g., medications, medical equipment, implants), and outcomes (e.g., readmissions, morbidities, patient satisfaction, symptoms) that are related to a particular medical condition or complaint of the patient over a period of time. Embodiments of the present invention may model multiple epochs of care for the same patient and may model epochs of care for multiple patients. Predictions and recommendations may be made based on the epoch of care data (including data relating to tests, treatments, and appointments spanning a wide range of times), possibly in addition to external data (e.g., contextual data, sensor data, medical history data) outside of the epoch of care.

Other features and advantages of various aspects and embodiments of the present invention will become apparent from the following description and from the claims.

### BRIEF DESCRIPTION OF THE DRAWINGS

FIG. 1A is a dataflow diagram of a system for providing epoch-centric healthcare according to one embodiment of the present invention;

FIG. 1B is a dataflow diagram of relationships between causes and symptoms, a disease, or a syndrome;

FIG. 1C is a data model diagram of an epoch of care model according to one embodiment of the present invention;

FIG. 1D is a data model diagram of relationships between and among epoch of care models, sub-epoch of care models, and epoch of care cohorts according to one embodiment of the present invention;

FIG. 1E is a diagram of engines used by embodiments of the present invention;

FIG. 1F is a diagram illustrating versions of an epoch of care model over time according to one embodiment of the present invention;

FIG. 2 is a flowchart of a method for determining whether data is associated with an epoch of care model according to one embodiment of the present invention;

FIG. 3 is a dataflow diagram of a system for correlating data with EOC according to one embodiment of the present invention; and

FIG. 4 is a flowchart of a method performed by the system of FIG. 3 according to one embodiment of the present invention.

### DETAILED DESCRIPTION

A computer-based system and method improves the efficiency (quality and/or cost) of healthcare services provided to a patient by modeling an epoch of care (EOC) of the patient and by using the epoch of care model to assist in the provision of healthcare services to the patient, such as by generating predictions of healthcare outcomes for the patient and by making recommendations for actions to be taken in connection with the provision of healthcare services to the patient. An epoch of care of a patient may include all services (e.g., treatments, diagnoses, prognoses, tests, tasks, communications, education), products (e.g., medications, medical equipment, implants), and outcomes (e.g., readmissions, morbidities, patient satisfaction, symptoms) that are related to a particular medical condition or complaint of the patient over a period of time. Embodiments of the present invention may model multiple epochs of care for the same patient and may model epochs of care for multiple patients. Predictions and recommendations may be made based on the epoch of care data (including data relating to tests, treatments, and appointments spanning a wide range of times), possibly in addition to external data (e.g., contextual data, sensor data, medical history data) outside of the epoch of care.

For example, if a particular patient is scheduled to have heart surgery, then an EOC for that heart surgery may include, for example:
all of the patient's visits to the hospital in connection with that heart surgery (such as visits before the heart surgery to perform tests on the patient, the visit to the hospital to perform the heart surgery itself, and visits after the heart surgery to track the patient's progress in recovering from the heart surgery);
medications prescribed and provided to the patient before, during, and after the heart surgery in connection with the heart surgery;
communications among the patient, informal caregivers (e.g., family members) and healthcare professionals involved in the heart surgery;
educational materials provided to the patient in connection with the heart surgery and data representing the patient's degree of comprehension of those materials;
coordination data that measures the frequency, quality, and/or patterns of coordination related to the heart surgery;
the patient's lifestyle (e.g., diet, exercise, sleep) during the heart surgery epoch of care;
implants implanted into the patient during the heart surgery; and
outcomes of the heart surgery, such as post-surgery infections, complications or improvements to the patient's heart function as a result of the heart surgery, changes in heart function, qualitative outcomes associated with the heart surgery (such as the patient's perceived pain and other feelings after the heart surgery), and changes in function (e.g., activities of daily living).

Having described certain features of embodiments of the present invention in general, features of particular embodiments of the present invention will now be described in more detail.

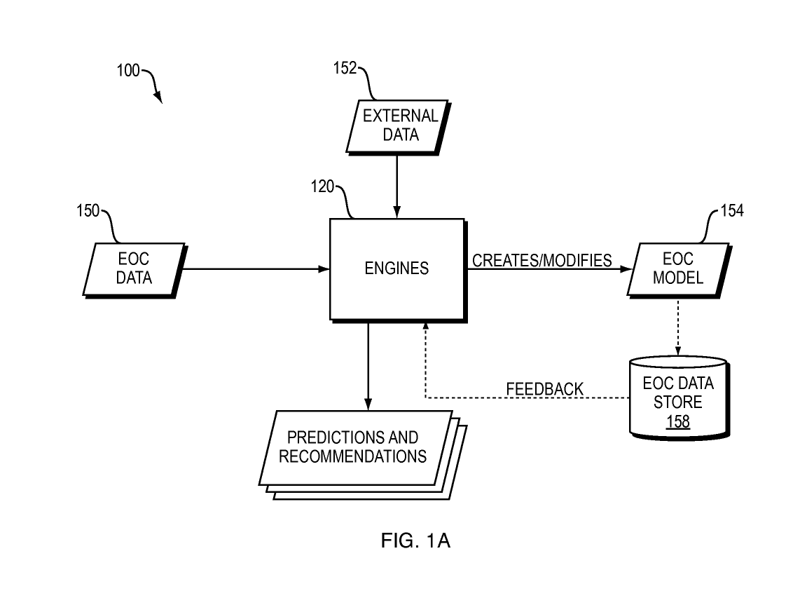

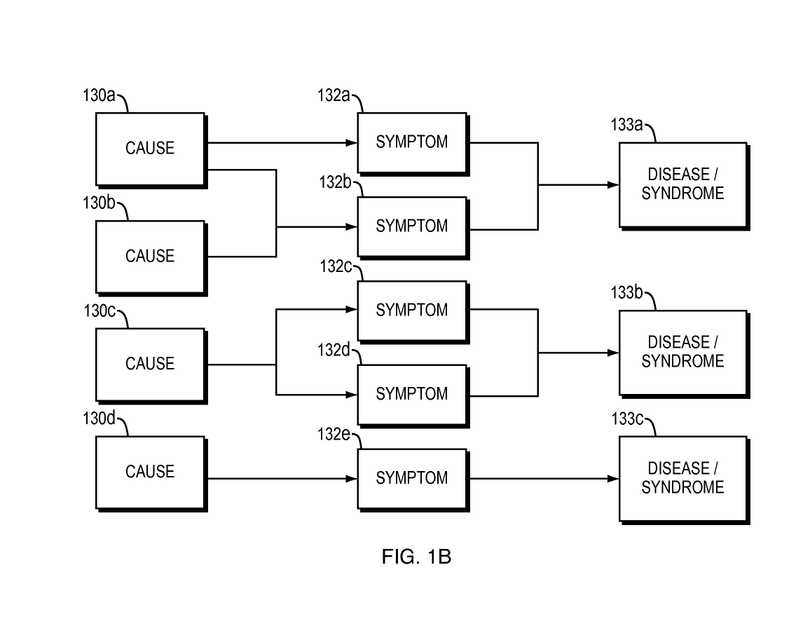

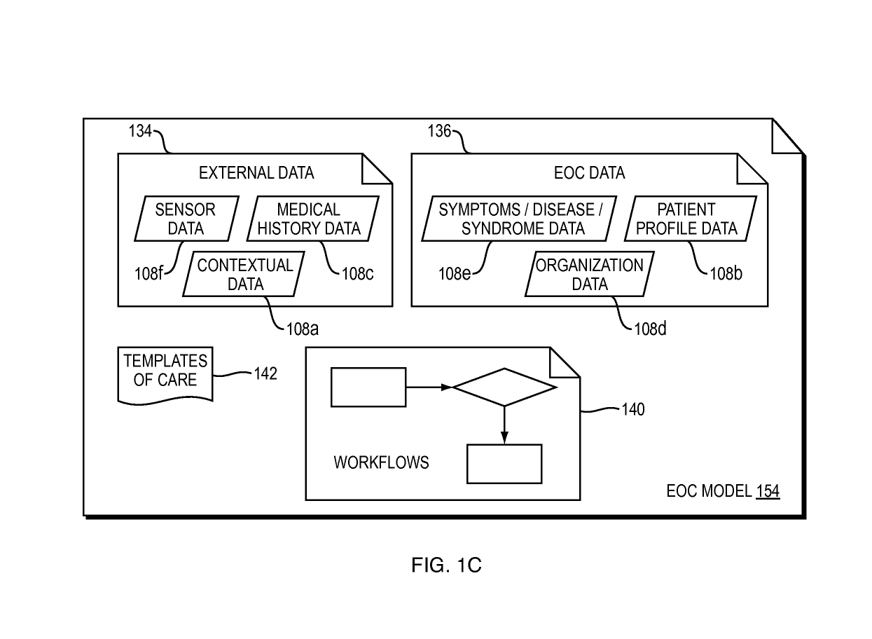

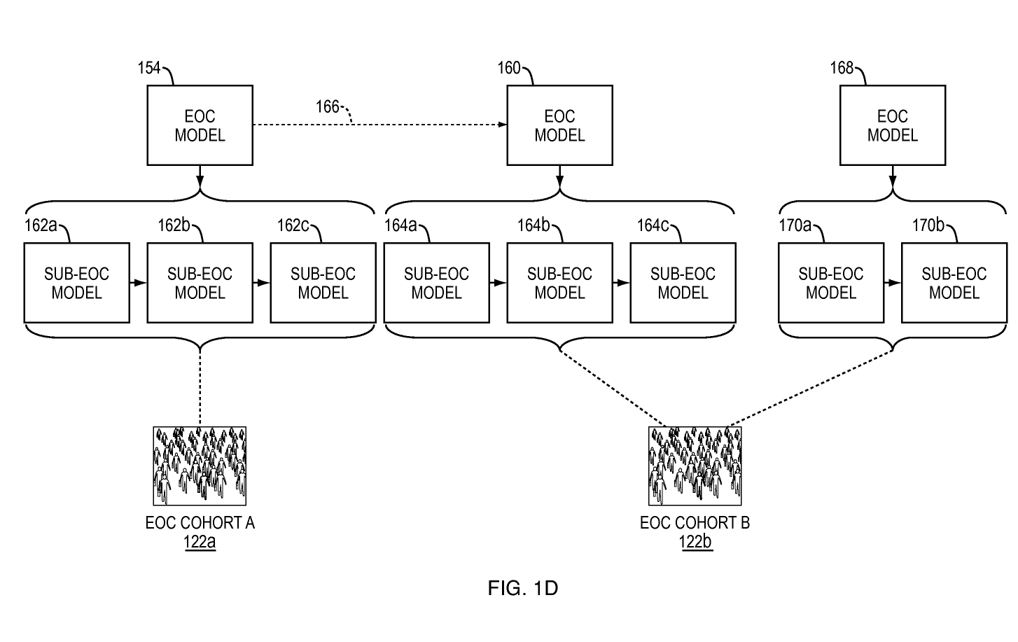

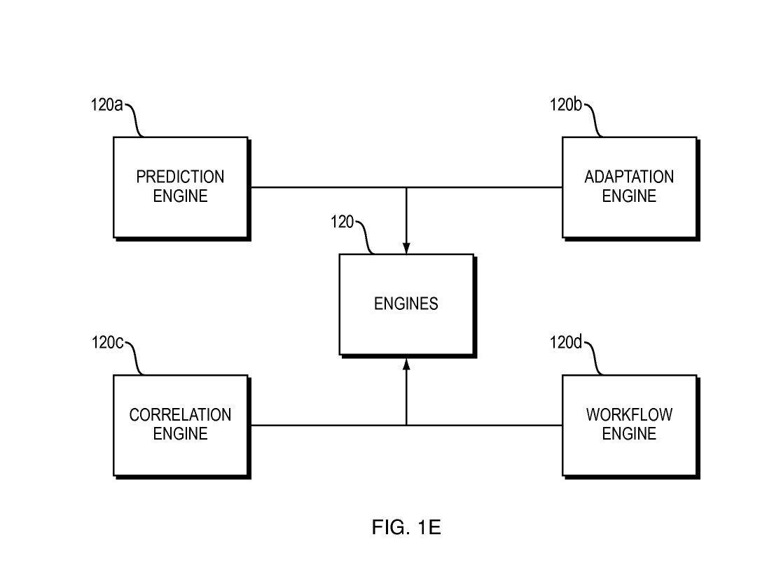

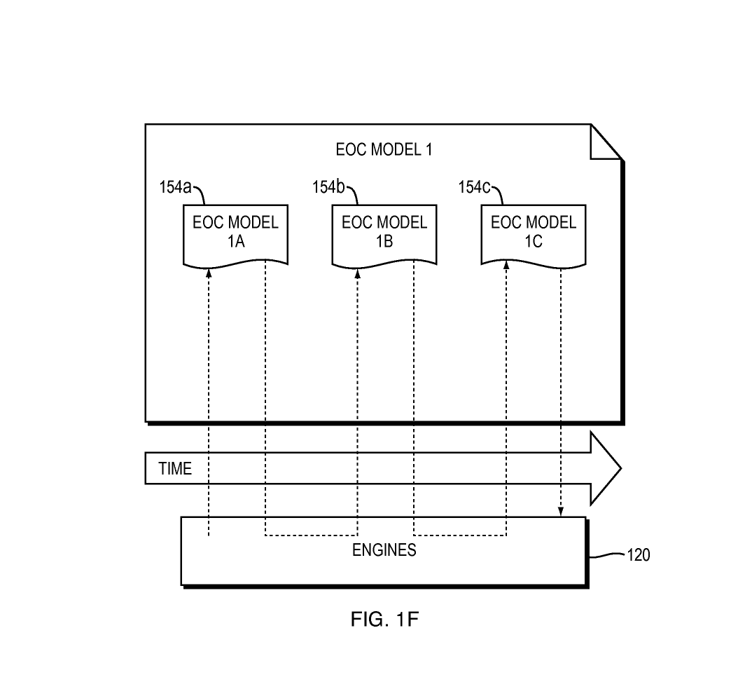

Referring to FIG. 1A, a dataflow diagram is shown of a system 100 for implementing healthcare system that provides predictions and recommendations based on epochs of care (EOCs) according to one embodiment of the present invention. In general, the system 100 includes an engine 120 that receives epoch of care (EOC) data 150 and external data 152 as input, and produces and/or updates an EOC model 154 based on the EOC data 150 and the external data 152. The engine 120 may also generate predictions and/or recommendations 156 based on the EOC model 154. In practice, the EOC model 154 may be stored in an EOC database 158, which may also store additional EOC models representing additional EOCs (not shown in FIG. 1A). The engine 120 may obtain data from the database 158 as input and update the EOC model 154 based on the data from the database 158, possibly in combination with the EOC data 150 and/or the external data 152. The EOC data 150, external data 152, EOC model 154, and/or EOC database 158 may be updated over time. The engine 120 may receive any such updated data as input and update the EOC model 154 based on any such updated data 154 over time.

For example, as shown in FIG. 1F, the contents of the EOC model 154 may vary over time. In FIG. 1F, EOC model 154a represents a first version of the EOC model 154 at a first time, the EOC model 154b represents a second version of the EOC model 154 at a second (later) time, and the EOC model 154c represents a third version of the EOC model 154 at a third (yet later) time. The EOC models 154a, 154b, and 154c may be created and/or updated by the engines 120. For example, as shown in FIG. 1F, the engines 120 may create EOC model 154a at a first time. At a second (later) time, the engines 120 may receive EOC model 154a (possibly in addition to other data) as input and, based on such input, create EOC model 154b. At a third (yet later) time, the engines 120 may receive EOC model 154b (possibly in addition to other data) as input and, based on such input, create EOC model 154c.

Although the models 154a-c may be stored distinctly within the EOC model 154, so that any of the data in any of the models 154a-c is accessible at any time. As another example, storing model 154b may replace some or all of the data in model 154a, and storing model 154c may replace some or all of the data in model 154b. Any updates to the model 154 (such as updating the model 154 to reflect model 154b) may be performed by the engine 120 and reflected in the database 158. It should be understood, therefore, that any data shown within the model 154 in FIG. 1F may in practice be stored as data within the database 158.

Although the engine 120 is shown as a single engine 120 in FIG. 1A, in practice the engine 120 may be implemented using one or more engines. For example, referring to FIG. 1E, an embodiment is shown in which the engine 120 includes four engines: a prediction engine 120a, an adaptation engine 120b, a correlation engine 120c, and a workflow engine 120d. Each of the engines 120a-d may perform a different function within the system 100. However, the division of the engine 120 into multiple engines 120a-d is merely an example and does not constitute a limitation of the present invention. Any reference herein to the engine 120 should be understood to refer to any one or more engines that may be used to perform the functions described, such as one or more of the engines 120a-d shown in FIG. 1E.

FIG. 1A illustrates a model 154 of a particular epoch of care (EOC) for a particular patient. The EOC model 154 may, for example, store data representing an EOC relating to a heart surgery performed in the past or scheduled to be performed in the future on the patient. The EOC model 154 may be implemented in any data structure or combination of data structures stored in any one or more non-transitory computer-readable media.

Although only one EOC model 154 for one patient is shown in FIG. 1A for ease of illustration, the system 100 may include any number of EOC models representing any number of EOCs of the same patient. For example, if the patient were to contract pneumonia, then treatment related to the patient's pneumonia may be stored in an additional EOC model (not shown in FIG. 1A) that is distinct from the EOC model 154. As another example, if the patient were to be scheduled for a second heart surgery in the future, then the second heart surgery may be represented in an additional EOC model (not shown in FIG. 1A) that is distinct from the EOC model 154 representing the first heart surgery.

Similarly, although FIG. 1A only shows an EOC model for one patient for ease of illustration, the system 100 may include any number of EOC models for each of any number of patients.

Furthermore, as illustrated in FIG. 1D, an EOC model may include any number of (including zero) sub-EOC models. For example, EOC model 154 includes sub-EOC models 162a, 162b, and 162c. Each of the sub-EOC models 162a-c may, for example, have the same structure as the EOC model 154, or a structure that is similar to but not the same as the EOC model 154. As a result, the EOC model 154 may be recursive to any level of recursion. For example, the EOC model 154 may contain EOC sub-model 162a, which may further contain one or more EOC sub-models (not shown). An EOC model may include data in addition to the EOC sub-models that it contains. For example, consider an EOC model representing an EOC for a particular syndrome. The EOC model may contain a first EOC sub-model representing a heart condition resulting from the syndrome and a second EOC sub-model representing a facial deformity resulting from the syndrome. The EOC model may contain information about how the conditions represented by the two EOC sub-models are related to each other. For example, consider a case in which the patient has several EOCs which initially appear to be independent of each other. Genetic data contained within the patient's profile data then enables the system 100 to determine that the multiple EOCs are associated with each other. Furthermore, contextual data (such as the patient's diet and exposure to pollution, which cause certain of the patient's genes to express themselves) may further be used by the system 100 to associate the multiple EOC models with each other. Embodiments of the invention may use the same techniques to identify previously-unidentified syndromes of a patient by identifying associations among multiple EOCs that are related to the same syndrome.

FIG. 1D further shows a second EOC model 160, which contains EOC sub-models 164a, 164b, and 164c. EOC models 154 and 160 may be related to each other, as indicated by relationship 166. For example, EOC model 154 and EOC model 160 may be sub-models of a higher-level EOC model (not shown).

As will be described in more detail below, an EOC model may be associated with a corresponding EOC cohort. For example, as illustrated in FIG. 1D, EOC model 154 is associated with EOC cohort 122a, while EOC model 160 is associated with EOC cohort 122b. As this example illustrates, different EOC models may be associated with different EOC cohorts. Furthermore, although not shown in FIG. 1D, the cohort associated with a particular EOC model may change over time. For example, the EOC cohort 122a associated with EOC model 154 may change over time.

A single EOC cohort may be associated with more than one EOC model. For example, as shown in FIG. 1D, EOC model 168 (which contains EOC sub-models 170a and 170b) is associated with EOC cohort 122b. As a result EOC cohort 122b is associated with two EOC models 160 and 168. More generally, any EOC cohort may be associated with any number of EOC models.

EOC sub-models may be used for any of a variety of purposes. For example, EOC sub-models may contain data representing epochs of care, as that term is used herein. As a result, an EOC model for a particular patient may contain multiple EOC sub-models, each of which represents a distinct EOC for that patient. For example, assuming that EOC model 154 is an EOC model for a particular patient, EOC model 154 may include: (1) EOC sub-model 162a, which may contain data representing a first heart surgery EOC for the patient; (2) EOC sub-model 162b, which may contain data representing a second heart surgery EOC for the patient; and (3) EOC sub-model 162c, which may contain data representing an incidence of pneumonia for the patient. In this way, a single EOC model for a particular patient (e.g., EOC model 154) may contain a plurality of EOC sub-models for the same patient and thereby tie together the EOCs represented by the EOC sub-models.

For example, a child with a facial deformity may undergo a series of operations related to that facial deformity over many years. Each such operation may be modeled by a distinct EOC model. All of those EOC models may be implemented as sub-models within a single higher-level EOC model. That higher-level EOC model may itself be one of multiple EOC models for the same patient. For example, if the patient has both a facial deformity and a heart condition, then treatments related to the patient's heart condition may be modeled by EOC models within a higher-level EOC model that is distinct from the EOC model for the facial deformity of the same patient.

The term “EOC model,” as used herein, applies equally to a “top-level” EOC model (e.g., EOC model 154) and to EOC sub-models at any level (e.g., EOC sub-models 162a-c and any sub-models thereof). Similarly, the term “EOC,” as used herein, applies equally to the epoch of care represented by a “top-level” EOC model (e.g., EOC model 154) and to epochs of care represented by EOC sub-models at any level (e.g., EOC sub-models 162a-c and any sub-models thereof). For example, EOC sub-model 162a is an example of an “EOC model” as that term is used herein, and EOC sub-model 162a represents an “EOC” as that term is used herein.

Any EOC model may contain a variety of data relating to the EOC represented by the EOC model. The following description provides examples of data that may be included within an EOC model. In practice, an EOC model need not include all of the data described herein, and may include data in addition to the data described herein. For example, an EOC model may include data representing any one or more of the following in any combination:
start time and end time of the corresponding EOC (e.g., represented as a combination of date and time);
care team associated with the corresponding EOC (e.g., the doctors, nurses, and other healthcare professionals who provide treatments as part of the EOC);
social data, such as data representing or otherwise relating to communications among actors associated with an epoch of care, such as the patient, doctors, nurses, and insurers.
services associated with the corresponding EOC, which may include any one or more of the following data:
   start time and end time of the service (e.g., represented as a combination of date and time);
   location of the service (e.g., any combination of healthcare facility, department, room, and geographic coordinates);
   test(s) performed as part of the service;
   treatment(s) applied as part of the service;
   medication(s) prescribed as part of the service;
   procedure(s) performed as part of the service;
   patient appointment(s) associated with the service (e.g., surgeries, tests, and follow-up visits, educational content and other media, communications, checklists);
diagnoses (primary and/or secondary) produced as a result of the service;
workflow templates (see description below), workflows (which may differ from the workflow templates from which they were created), and records of executions of workflow templates associated with the corresponding EOC;
profile data of the patient associated with the corresponding EOC;
external data (e.g., contextual data) associated with the corresponding EOC;
connections to related EOC models (e.g., EOC models that are sub-models of the same parent EOC model as the corresponding EOC model) that are related to the corresponding EOC;
organizational data (see description below);
EOC cohorts for the corresponding EOC; and
patient outcomes, such as:
   test outcomes;
   treatment outcomes;
   medication outcomes;
   symptoms.

As mentioned above, an EOC model may, for example, contain data such as: (1) data about scheduled and/or predicted future events (e.g., scheduled appointments, predicted treatment outcomes); (2) data about current events (such as test outcome data obtained from sensors in real-time as the tests are being performed on a patient); and (3) data about actual events (e.g., actual treatment outcomes). Since features of actual events may differ the features that were scheduled/predicted for such events, an EOC model may store one or both of scheduled/predicted data and actual data for any of the elements described herein as being stored in an EOC model. For example, an EOC model may store a scheduled start and end time for a particular appointment and, upon completion of the actual appointment, also store the actual start and end time for the appointment. As a result, the EOC model may store both the scheduled start/end times and actual start/end times for the same appointment. Similarly, the EOC model may, for example, store both predicted and actual test outcomes, predicted and actual treatment outcomes, and predicted and actual medication outcomes.

This is merely one example of various ways in which any particular EOC model may be updated dynamically over time. For example, as additional appointments related to an EOC are scheduled, data representing the newly-scheduled appointments may be added to the corresponding EOC model. Similarly, as new treatments related to an EOC are applied to a patient, data representing the newly-applied treatments may be added to the corresponding EOC model. Similarly, as new outcomes related to an EOC are obtained (e.g., from the external data 152), data representing the newly-observed outcomes may be added to the corresponding EOC model. More generally, any new data obtained that is related to a particular EOC may be used to add, remove, or modify data within the corresponding EOC model at any time.

As described herein, a start time and/or end time may be associated with an EOC model. More generally, any element of an EOC model may be associated with time-related data representing, for example, a start time and/or end time of the element. For example, an appointment within an EOC model may be associated with timestamps representing the appointment's start time and end time. As another example, a test within an EOC model may be associated with timestamps representing the test's start time and end time. The system 100 may determine whether such time-related data is associated (e.g., correlated) with other data in any of the ways disclosed herein. As a result, such time-related data may, for example, be used to make recommendations and/or predictions in connection with an EOC model.

The ability of embodiments of the present invention to store a variety of data related to a particular EOC within a unified EOC model representing the EOC enables embodiments of the present invention to perform a variety of useful functions. Examples of some of those functions will now be described.

As described above, a particular EOC model may be updated dynamically over time to incorporate a variety of information about the corresponding EOC as that information is generated or otherwise discovered. Embodiments of the present invention may update an EOC model based on data from a wide variety of sources. Such data may or may not include information that explicitly indicates the EOC(s) with which the data are associated. As a result, embodiments of the present invention may need to determine whether data is associated with individual EOC models using any of a variety of techniques, such as the following.

Referring to FIG. 1C, an EOC model, such as EOC model 154, may include any of a variety of data. The particular data shown in FIG. 1C is merely an example and does not constitute a limitation of the present invention. As shown in FIG. 1C, the EOC model 154 may include external data 134, EOC data 136, template of care data 142, and workflow data 140. The external data 134 within the EOC model 154 may be derived from the external data 152 (FIG. 1A) by the engine 120. Similarly, the EOC data 136 within the EOC model 154 may be derived from the EOC data 150 (FIG. 1A) by the engine 120. The external data 134 may, for example, include contextual data 108a, medical history data 108c, and sensor data 108f. The EOC data 136 may, for example, include patient profile data 108b, symptom/disease/syndrome data 108e, and organization data 108d. The various data shown in FIG. 1C will be described in more detail below.

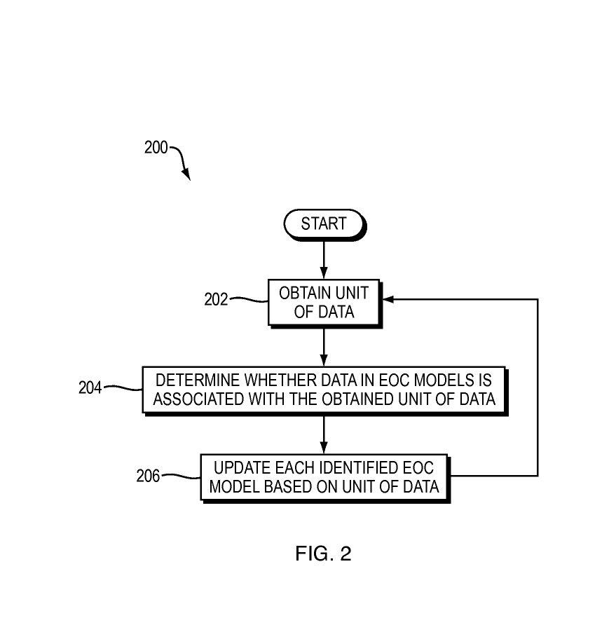

Referring to FIG. 2, a flowchart is shown of a method 200 that is performed by the system 100 of FIG. 1A to determine whether data is associated with EOC models according to one embodiment of the present invention. The method 200 obtains a unit of data (FIG. 2, operation 202). The unit of data may be any of a variety of units of data, such as a unit of data (e.g., record) within contextual data 108a, profile data 108b (such as data stored in external clinical databases), medical history data 108c, demographic data, coordination data, sensor data 108f, a patient database (which may store some or all of the data 108a-f and/or data derived therefrom), structured EOC data, or unstructured contextual data. Examples of these and other kinds of data that may be associated with an EOC model will be described in more detail below.

In general, data 108a-f may, in whole or in part, represent causes of symptoms associated with syndromes and/or chronic diseases of one or more patients. For example, the data 108a-f may represent causes 130a-d, symptoms 132a-e, and chronic diseases/syndromes 133a-c (FIG. 1B) for which the patient is treated as part of the epoch of care represented by epoch of care model 152. In particular, cause 130a is a cause of symptom 132a; causes 130a-b are causes of symptom 132b; cause 130c is a cause of symptom 132c; cause 130c is a cause of symptom 132d; and cause 130d is a cause of symptom 132e. Furthermore, symptoms 132a-b are symptoms of disease/syndrome 133a; symptoms 132c-d are symptoms of disease/syndrome 133b; and symptom 132e is a symptom of disease/syndrome 133c.

The causes 130a-d, symptoms 132a-e, and diseases/syndromes 133a-c are shown in FIG. 1B merely for ease of understanding, and are not necessarily represented explicitly within any data in the system 100. Instead, the causes 130a-d, symptoms 132a-e, and diseases/syndromes 133a-c may be implicit within data in the system 100 (e.g., data 108a-f). The causes 130a-d shown in FIG. 1B, in other words, are the true causes of the syndromes/chronic diseases 133a-c, whether or not those causes 130a-d and syndromes/diseases 133a-c are known to users of the system 100 and whether or not those causes 130a-d and syndromes/diseases 133a-c are represented explicitly by data in the system 100. One goal of embodiments of the present invention is to improve the accuracy and efficiency with which the causes 130a-d, symptoms 132a-e and syndromes/diseases 133a-c, or approximations thereof, may be derived from data within the system 100, such as the data 108a-f, and other data disclosed herein.

The method 200 determines whether the obtained unit of data is related to data in the EOC models stored in the system 100 to identify zero, one, or more EOC models associated with the obtained unit of data (FIG. 2, operation 204). The method 200 may perform operation 204 in any of a variety of ways. In general, the method 200 may determine whether the obtained unit of data satisfies some relationship criterion in connection with data within an EOC model and determine that the obtained unit of data is associated with the EOC model only if the obtained unit of data is determined to satisfy the relationship criterion. One way in which the method 200 may perform operation 204 is by performing statistical correlation of the obtained unit of data with the EOC models to identify one or more correlations between the obtained unit of data and data within the EOC models. The method 200 may then determine whether each such correlation satisfies some significance criterion which may, for example, be based on prior domain-specific knowledge. The method 200 may determine that the obtained unit of data is associated with a particular unit of data in an EOC model only if the correlation between the obtained unit of data and the data in the EOC model satisfies the significance criterion. In this example, a particular unit of data may be determined to be associated with an EOC model only if: (1) the unit of data and the EOC model satisfy the specified relationship criterion (e.g., the correlation between the unit of data and the EOC model is statistically significant); and (2) the unit of data and the EOC model satisfy the specified significance criterion (e.g., the correlation between the unit of data and the EOC model satisfies a domain-specific threshold). As this example indicates, the mere existence of a statistically significant correlation between the particular unit of data and the EOC model may not be sufficient to result in the method 200 determining that the unit of data is associated with the EOC model. One benefit of this approach is that it may be used to enable embodiments of the present invention to distinguish between statistical significance and clinical significance, and not to conclude that a particular unit of data is associated with a particular EOC model unless the relationship between the particular unit of data and the particular EOC model is statistically significant and/or clinically significant.

Embodiments of the present invention may perform statistical correlation in any of a variety of ways. For example, embodiments of the present invention may perform correlation using multilevel modeling, which includes techniques for modeling parameters that vary at more than one level. Multilevel modeling thereby allows nesting of data within other data (such as nesting of patients within doctors, doctors within clinics, and clinics within accountable care organizations) to be taken into account accurately when performing correlation. One example of multilevel modeling that may be used to perform correlation is hierarchical linear modeling.

Another technique that may be used by embodiments of the present invention in the process of correlation is to create best practice frontiers and/or efficiency frontiers. For example, cost data and quality data may be used to create a cost/quality frontier. Examples of techniques that may be used to create such frontiers include data envelopment analysis (DEA) and stochastic frontier analysis (SFA).

Embodiments of the present invention may use any of a variety of tests of statistical significance, such as the chi-square test, the maximum-likelihood estimate (MLE), and the maximum a-posteriori estimate (MAP).

Embodiments of the present invention may use any of a variety of forecasting methodologies to make predictions and/or recommendations. Examples of such methodologies include the autoregressive-moving-average model and the Delphi method (which may, for example, be used to leverage expert opinion to determine optimal workflows).

Embodiments of the present invention may use any of a variety of techniques to performing learning and/or adaptation, such as for purposes of improving workflows and templates of care. Examples of techniques that may be used for such purposes include artificial neural networks, adaptive clustering, and Hidden Markov Models (HMMs).

Embodiments of the present invention may use any of a variety of techniques to match and link records to each other (e.g., to match and link patients to records or to match and link patients to physicians). Examples of techniques that may be used for such purposes include probabilistic record linkage and deterministic record linkage.

Embodiments of the present invention may use any of a variety of techniques to identify EOC cohorts 122. Examples of techniques include artificial neural networks, adaptive clustering, and Hidden Markov Models (HMMs).

The method 200 may perform operation 204 in any of a variety of ways. For example, if the unit of data explicitly specifies one or more EOC models with which the unit of data is associated (such as by containing unique identifiers of such EOC models), then the method 200 may determine that the unit of data is associated with the corresponding EOC model(s) directly based on the explicit specification of the unit of data.

If the unit of data does not explicitly specify the EOC model(s) with which it is associated, then the method 200 may perform operation 204 in any of a variety of ways. For example, operation 204 may use the unit of data to query the EOC models in the system 100 using any kind(s) of logic, such as Boolean logic and/or fuzzy logic. If the search performed using the query results in one or more matching EOC models, then the method 200 may conclude that the matching EOC model(s) as associated with the unit of data. For example, if the unit of data is a record indicating that a patient named “John Smith” attended an appointment from 1:00 pm-2:00 pm on Aug. 18, 2012, and one of the EOC models in the system 100 indicates that a patient named “John Smith” was scheduled to attend an appointment from 1:00 pm-2:00 pm on Aug. 18, 2012, then the method 200 may conclude that the unit of data matches and thereby is associated with the EOC model containing the scheduled appointment. In this example, fields such as patient name and appointment time are used to query EOC models. Other examples of fields that may be used to query EOC models include, but are not limited to, symptoms, location, doctor name, medications, and test data.

More generally, the method 200 may perform operation 204 by using any of a variety of statistical techniques to correlate the unit of data with one or more EOC models. For example, in general, the method 200 may correlate data in the unit of data with corresponding data in the EOC models, such as patient identifying data (e.g., patient name, date of birth, and Social Security Number), appointment data (e.g., appointment location and start/end time), patient symptoms, doctor name, medications, and test date. The method 200 may, for example, conclude that the unit of data is associated with a particular EOC model if the statistical correlation between the unit of data and the EOC model is sufficiently strong, e.g., if the correlation exceeds some predetermined threshold.

As a concrete example, if the unit of data indicates that a particular patient has arrived at a hospital complaining of chest pain one week after having undergone heart surgery, the method 200 may, in operation 204, use statistical techniques to determine that chest pain occurring one week after heart surgery is strongly correlated with the heart surgery procedure. As a result, the method 200 may determine, in operation 204, that the patient's heart surgery EOC model is associated with a readmission outcome representing the patient's readmission to the hospital for chest pain.

Once the method 200 has identified the EOC model(s), if any, with which the unit of data is associated, the method 200 updates the identified EOC model(s) based on the unit of data (FIG. 2, operation 206). The method 200 may perform operation 206 in any of a variety of ways. For example, the method 200 may add the unit of data to the identified EOC model(s) (e.g., by adding a record of an additional procedure that has been performed on a patient). As another example, the method 200 may modify existing data within the identified EOC model(s) based on the unit of data (such as by changing the date of an appointment that has been rescheduled). As another example, the method 200 may delete data from the identified EOC model(s) based on the unit of data (such as by removing a medication from a patient's list of current medications).

The method 200 may return to operation 202 and thereby loop over operations 202-206 repeatedly. In this way, the method 200 may be used to associate a wide variety of data, such as any of the EOC data 150 and the external data 152 with the EOC models stored in the system 100. The method 200 may be performed repeatedly (e.g., periodically) so that it can update the EOC models in the system 100 in response to changes (e.g., additions, modifications, and deletions) to data stored in the system 100. As a result of performance of the method 200, changes to data in the system 100 may be reflected by changes to EOC models in the system 200 in real-time. The units of data processed by the method 200 may be pulled by the method 200 and/or pushed to the method 200.

Embodiments of the present invention may create, store, modify, access, and otherwise process a wide variety of data, including but not limited to the following.

Sensor Data:

The term “sensor data” 108f is used herein to refer to data received from a patient dynamically (e.g., in real-time) using one or more sensors. Examples of sensor data include but are not limited to:
conventional computer input device data, such as data received from a computer keyboard, mouse, touchpad, or touchscreen;
audio data, such as data received via a microphone (such as data representing human speech);
biometric data, such as data relating to the patient's heart rate, blood pressure, body temperature, or weight, received from sensors such as heart rate monitors, thermometers, and scales;
handwriting data, such as data received via a tablet using a stylus or human finger; and
accelerometer data, such as data representing acceleration obtained via an accelerometer embedded in a tablet computer or smartphone.

Profile Data:

The term “profile data” 108b is used herein to refer to data that is related to a particular patient, but that is not obtained via sensors. Examples of profile data include but are not limited to:
medical history data 108c (e.g., data that may be stored in a Continuity of Care Document (CCD)), such as the patient's name, birthdate, past and current medical conditions, and past and current prescriptions;
data in unstructured documents, such as notes written about the patient by a doctor, nurse, or other healthcare professional;
data about the patient in publicly-available databases, such as on web pages or social networking sites;
ethnicity;
allergies;
medications (current and past);
immunizations;
language(s) spoken, and an indication of which language is the primary language;
presence or absence of a healthcare proxy;
marital status;
profession;
home address;
age;
gender;
problem list (compilations of clinically relevant physical and diagnostic concerns, procedures, and psychosocial and cultural issues that may affect the health status and care of the patient);
complaint list (data representing the patient's descriptions of the symptoms they are experiencing);
the patient's quality of life preferences, e.g., types of medical treatment that the patient prefers or does not prefer, whether the patient prefers to minimize time away from home, and the patient's food preferences;
religion;
sexual orientation;
socioeconomic status;
healthcare literacy;
literacy;
education.

Contextual Data:

The term “contextual data” 108a is used herein to refer to data that is not related to any particular patient. Contextual data that is associated with an EOC model may be associated with time-related data that may or may not fall outside of (e.g., before or after) the time range of the EOC model. Examples of contextual data include but are not limited to:
weather data (units of which may be stamped with characteristics such as time and location);
time data (e.g., time of day, month, and/or year);
location data (which may specify locations in any way, such as by using any combination of geographic coordinates, street address, name (e.g., “Mercy Hospital”), department, floor, or room number);
geographic data (e.g., indicating the distance between the patient's current location or home and the patient's healthcare provider);
traffic data (e.g., in the vicinity of the patient's current location, the patient's home, and/or the patient's healthcare provider);
aggregate clinical data, such as data obtain from clinical trials across a wide range of test subjects;
environmental data (e.g., pollution, natural disaster, man-made disaster); and
economic environment data (e.g., recession, depression).

Aggregate clinical data may be associated with various levels of evidence. The level of evidence associated with any particular unit of aggregate clinical data may be taken into account by the system 100 when making predictions and/or recommendations based on that unit of aggregate clinical data. For example, aggregate clinical data associated with a higher levels of evidence may be given more weight by the system 100 than aggregate clinical data associated with lower levels of evidence. Examples of levels of evidence that may be associated with aggregate clinical data include the following:
Level I: evidence obtained from at least one properly designated randomized controlled trial.
Level II-1: Evidence obtained from well-designed controlled trials without randomization.
Level II-2: Evidence obtained from well-designed cohort or case-control analytic studies, preferably from more than one center or research group.
Level II-3: Evidence obtained from multiple time series with or without the intervention. Dramatic results in uncontrolled trials might also be regarded as this type of evidence.
Level III: Opinions of respected authorities, based on clinical experience, descriptive studies, or reports of expert committees.

Outcome Data:

The term “outcome data” is used herein to refer to patient outcomes of any of a variety of kinds at any level of granularity. Outcome data for a particular patient may, for example, be obtained from the external data 152 and stored in the patient's EOC model 154, e.g., in the profile data 108b and/or medical history data 108c. Examples of outcome data include but are not limited to:
test outcome data representing the outcome of a test, or any part thereof, performed on a patient;
a clinical outcome, such as an outcome of a medical treatment (e.g., procedure), or any part thereof, applied to a patient, such as a readmission, morbidity, mortality, or recovery resulting from the treatment; and
an outcome experienced by a patient outside of a healthcare facility (e.g., slipping and falling at home).
qualitative outcomes (e.g., the patient's perceived pain and other feelings after a procedure, patient satisfaction, family satisfaction), and changes in function (e.g., activities of daily living).

Any predicted outcome may be associated with an estimated probability of the outcome. Furthermore, any particular outcome prediction may be represented as a set of one or more predicted outcomes, each of which is associated with a corresponding probability. For example, predicted outcomes of heart surgery may be represented by a set of outcomes including an outcome of chest pain with a probability of 50% and an outcome of dizziness with a probability of 30%. Furthermore, outcome data may be associated with a particular treatment (e.g., procedure or test). For example, one set of outcome data may be associated with a particular heart surgery on a particular patient within an EOC of that patient, while another set of outcome data may be associated with a particular blood transfusion of that patient within the EOC of that patient.

Epoch of Care (EOC) Data:

The term “epoch of care data” or “EOC data” is used herein to refer to any data that may be associated with (e.g., stored within and/or referenced by) an epoch of care model, such as any data described herein as capable of being stored in the epoch of care model 154. The term “epoch of care data” may refer to data stored in one or more EOC models. In general, an EOC model may include any number of attributes (e.g., start time, end time) and any number of functional elements (e.g., procedures, appointments, tests).

Social Data:

Social data, such as data representing or otherwise relating to communications among actors associated with an epoch of care, such as the patient, doctors, nurses, and insurers. Such social data may be mined using any of the techniques disclosed herein to determine, for example, whether the patient has a healthcare proxy, whether anyone in the patient's family has watched educational videos provided to them as part of the epoch of care, and whether communication is occurring between the patient and the surgeon's coordinator. Social data may, for example, be social data created by or otherwise contained within external online social networking systems, such as Facebook, Twitter, and LinkedIn.

Coordination Data:

Coordination data may include data that measures the frequency, quality, and/or patterns of coordination related to a particular epoch of care. Sources of coordination data 108e may include, for example, coordination surveys that ask about trust, frequency of interaction, etc.; data representing the frequency, timing and patterns of secure messaging among participants in the epoch of care; text analysis of messages that are sent to look at the types of coordination activities and communications that are taking place within the epoch of care; time stamps of accessing of patient information around the time of a hand-off from, for example, a hospital to a rehabilitation facility.

Genetic Data:

Genetic data may include, for example, the patient's genetic sequence. Such a genetic sequence may be obtained, for example, through the use of a commercial service such as 23andMe or deCODEme.

Organizational Data:

Organizational data 108d may represent, for example, one or more organizations (e.g., hospitals, departments, insurers) associated with an epoch of care. A single epoch of care may be associated with multiple organizations. More generally, organizational data may include data collected at the organizational level. For example, organizational data may be an aggregation of data that relates to individual actors (e.g., physicians and/or patients). As another example, organizational data may include:
statistics derived from individual data, such as the average frequency of communication between surgeons and coordinators, derived from analysis of individual communications (e.g., emails and telephone calls);
data from leadership surveys at a particular clinic or hospital;
frequency of team meetings;
data relating to bottlenecks (as in the case of a patient room for pre-admissions screen that can only support a maximum of 30 screenings per day);
staffing levels within a particular hospital; and
resource levels within a particular hospital.

Diagnosis Data:

Diagnosis data may include any data representing one or more diagnoses of the patient within the epoch of care, such as in the form of ICD-9 or ICD-10 codes and groupings such as diagnosis related groupings (DRGs).

Procedure Data:

Procedure data may include data representing one or more procedures performed on the patient within the epoch of care, such as in the form of CPT codes and/or HCPCS codes.

Informal Caregiver Data:

Informal caregiver data may include data about family members, friends, and other caregivers of the patient who are not formally involved in providing healthcare services to the patient.

Educational Data:

Educational data may include data about educational modules provided to the patient within the epoch of care and data representing the degree to which the patient has comprehended the contents of those educational modules.

Checklist Data:

Checklist data may include data representing checklists for actions to be taken and/or actions actually taken in connection with the patient's epoch of care.

Legal Data:

Legal data may include data representing legal documents related to the epoch of care (e.g., advanced medical directives, powers of attorney, healthcare proxies, DNR/DNI orders).

Research Data:

Research data may include data obtained from any research source, such as data from research studies on the natural history of disease, genetic data, clinical trial data, and/or medical journals (e.g., JAMA or NEJM).

Document Data:

Document data may include any documents related to the epoch of care (e.g., photographs, scanned notes, and spreadsheets).

Quality of Care Data:

Quality of care data may indicate the quality of any care provided to the patient within the epoch of care. These would be standardized measures that are either process measures (i.e., were specific treatments applied in a given case as recommended) or outcome measures (i.e., did the patient reach certain clinical outcomes) e.g., reduced cholesterol, having an INR in range (measure of the correct dosage of anti-coagulants).

Cost of Care Data:

Cost of care data may indicate the cost of care provided to the patient within the epoch of care as measured by methods such as but not limited to insurance claims data.

Product Data:

Product data may include, for example, products used by the patient (e.g., a cane, inhaler, or pacemaker), products used during a treatment (e.g., a scalpel, stent, or defibrillator), and products used by a test (e.g., a tablet computer, stethoscope, or treadmill). Data representing a product may be stored in association with any element of an epoch of care.

For ease of illustration, only some types of data are illustrated in FIG. 1. Any types of data not shown in FIG. 1, however, may be included within the system 100 of FIG. 1 according to embodiments of the present invention.

Any reference herein to creation, storage, modification, or other processing of data should be understood to be applicable, without limitation, to any of the kinds of data described above (e.g., sensor data, profile data, contextual data, outcome data, and epoch of care data). For example, the “units of data” in the method 200 of FIG. 2 may include units of any one or more of sensor data, profile data, contextual data, outcome data, and epoch of care data. As this implies, an epoch of care model may include or otherwise be modified based on any of the other kinds of data described herein.

The use of sensor data, profile data, contextual data, and outcome data to update EOC data is merely one example of ways in which various data processed by the system 100 of FIG. 1 may be used to update each other in a feedback cycle. Other examples of ways in which various kinds of data processed by the system 100 may be used to update other kinds of data include but are not limited to the following:
Sensor data 108f obtained from sensors may be used to modify the test data by, for example, selecting tests to perform and/or by modifying existing tests performed on the patient.
Sensor data 108f obtained from sensors may be associated with and stored in individual EOC models.
Sensor data 108f obtained from sensors may be provided to the engine 120 for use in making predictions and/or recommendations for treatment of the patient.
Outcome data may be associated with and stored in individual EOC models.
Outcome data may be provided to the engine 120 for use in making predictions and/or recommendations for treatment of the patient.

The system 100 also includes an engine 120 for making predictions and recommendations in connection with the epochs of care represented by epoch of care models within the system 100. In general, the engine 120 may receive as input any of the data within the system 100, such as any one or more of the contextual data 108a, profile data 108b, medical history data 108c, organization data 108d, symptom/disease/syndrome data 108e, sensor data 108f, EOC data 102, demographic data, coordination data, and outcome data. The engine 120 may generate predictions and/or recommendations based on the data it receives. For example, the engine 120 may generate a prediction and then generate a recommendation based on the prediction.

The predictions/recommendations generated by the engine 120 may be predictions/recommendations for, e.g.:
the selection and/or modification of tests to perform on a patient as part of an epoch of care;
treatments to apply to a patient as part of an epoch of care;
products to use in connection with an epoch of care (e.g., medications to prescribe to a patient);
appointments to schedule for a patient as part of an epoch of care;
communications to send to a patient or assigned staff person as part of an epoch of care;
educational materials to provide to a patient as part of an epoch of care;
resources to utilize in connection with the provision of healthcare services to a patient within an epoch of care, such as equipment to schedule for use in connection with a patient appointment; and
labor to schedule in connection with the provision of healthcare services to a patient within an epoch of care.

A prediction/recommendation may be targeted at a particular EOC. As a result, the engine 120 may tag any predictions/recommendations it generates with an identifier of the EOC model associated with the prediction/recommendation. As a result, the prediction/recommendation may easily be stored within the associated EOC model without the need to statistically correlate the prediction/recommendation with the associated EOC model.

A prediction/recommendation may be targeted at a plurality of EOCs, such as the EOC cohorts 122, in which case the engine 120 may tag the prediction/recommendation with identifiers of the EOC models associated with the prediction/recommendation and then store the prediction/recommendation within all of the associate EOC models. As another example, a prediction/recommendation may be associated with one or more people, such as one or more patients (independent of their EOCs) or one or more healthcare professionals (e.g., doctors or nurses). A recommendation/prediction may be associated with both an EOC and a person.

For example, the engine 120 may use statistical techniques to correlate the various data it receives to make predictions about the future outcome of a particular EOC, such as the EOC represented by EOC model 154. For example, the engine 120 may develop, for a particular EOC model, such as EOC model 154, a set of EOC cohorts 122a. The EOC cohorts 122a includes a plurality of EOC models that have been determined by the engine 120 to be sufficiently similar to the EOC 154. The engine 120 may develop the EOC cohorts 122a by, for example, using statistical techniques to correlate the EOC model 154 with all other EOC models in the system 100 and storing, in the EOC cohorts 122a, the subset of all EOC models that exceed some threshold of correlation with the EOC model 154.

As this description applies, the EOC cohorts 122a may differ from one EOC model to another. For example, the EOC model 160 may have its own set of EOC cohorts 122b that differs from the EOC cohorts 122a of EOC model 154.

Once the engine 120 has developed the EOC cohorts 122a for the EOC model 154, the engine 120 may make predictions and/or recommendations for the EOC model 154 in any of a variety of ways. For example, the engine 120 may extrapolate from data within the EOC model 154 based on data (e.g., about future outcomes) contained within the EOC cohorts 122a that is lacking in the EOC model 154. For example, if the EOC model 154 indicates that the patient is scheduled for a particular kind of heart surgery, and the EOC cohorts 122a contain data indicating a 90% success rate for the same kind of heart surgery, then the engine 120 may generate a prediction that the heart surgery represented by EOC model 154 has a 90% chance of success.

In the example just described the engine 120 generates a prediction based solely on the EOC cohorts 122a. More generally, the engine 120 may make predictions based on a combination of any of the kinds of data disclosed herein. For example, the engine 120 may make its prediction based on a combination of the EOC cohorts 122a, contextual data 108a, and demographic data. Based on such additional data, the engine 120 may make a different prediction, such as that the heart surgery's likelihood of success is 85% or 95%. As another example, the engine 120 may determine, based on the EOC cohorts 122a and weather data, that patients discharged after total knee replacement surgery during the winter are more likely not to attend physical therapy sessions. Based on this determination, the engine may predict that a particular patient who is discharged from total knee replacement surgery during the winter is likely not to attend physical therapy sessions, and that the patient is likely to be readmitted for knee problems.

The engine 120 may also make recommendations for the provision of healthcare services to the patient corresponding to the EOC model 154. Such recommendations may include, for example, recommendations about which tests to perform on the patient, how to modify parameters of tests performed on the patient, which treatments to apply to the patient, which medications to prescribe to the patient, and which appointments to schedule for the patient (including, for example, the location, time, and duration of the appointment).

For example, the engine 120 may identify healthcare services represented in the EOC cohorts 122a that are lacking from the EOC model 154 and recommend that the lacking healthcare services be provided to the patient represented by the EOC model 154. For example, if the patient is over 60 years old and is scheduled for a particular kind of heart surgery, and the EOC cohorts 122a indicate that patients who are over 60 years old have a higher rate of survival from the same kind of heart surgery if they are prescribed a particular medication beginning one week before the surgery, then the engine 120 may recommend that the medication be prescribed to the patient beginning at least one week before the surgery. Although in this example the recommendation is based on the EOC cohorts 122a, more generally the recommendation may be based on any combination of data within the system 100.

Any prediction or recommendation generated by the engine 120 may be implemented automatically. For example, a recommendation generated by the engine 120 may be used to update the corresponding EOC model 154 automatically, such as by adding a scheduled appointment to the EOC model 154 automatically. Alternatively, the engine 120 may notify a human user (e.g., a doctor, nurse, or other healthcare professional) of predictions and recommendations that it generates, without implementing such predictions or recommendations automatically. The healthcare professional may be provided with an opportunity to review the prediction/recommendation, and to accept, reject, or modify the prediction/recommendation. If the healthcare professional accepts the prediction/recommendation, then the engine 120 may implement the prediction/recommendation. If the healthcare professional rejects the prediction/recommendation, then the engine 120 may not implement the prediction/recommendation. If the healthcare professional modifies the prediction/recommendation, the engine 120 may implement the prediction/recommendation in its modified form.

The engine 120 may be used to manage various other data within the system 100 that may be used to facilitate providing healthcare services to patients based on epochs of care. For example, the system 100 may include workflows 140, which the engine 120 may create and modify in response to other data within the system. In general, each individual workflow in the set of workflows 140 is associated with a particular EOC model and drives activity within that EOC model. For example, as described earlier, an EOC model may include data representing a set of appointments for the corresponding patient. The engine 120 may create such a set of appointments within the EOC model based on a workflow which specifies that a patient who is scheduled to have a kind of surgery specified by the EOC model should have a particular set of pre-surgical procedures performed at specified intervals in advance of the surgery. Elements of a workflow may include, for example:
appointments, including properties such as date (which may be specified relative to other appointments in the workflow, or as absolute dates), location, doctor, procedure(s) to be performed, and test(s) to be applied (as specified, for example, by order sets);
rules that govern the actions that are performed (automated, semi-automated or manual);
actions to be performed outside of appointments (e.g., generating invoices, updating database records, making followup calls to the patient);
communications to send to a patient or assigned staff person as part of an epoch of care;
educational materials to provide to a patient as part of an epoch of care;
resources to be allocated to the workflow;
labor to be scheduled for use in the workflow (identified, for example, by role (e.g., doctor, nurse) and/or by a unique identifier (e.g., full name and/or social security number) of the person whose labor is to be scheduled).

Elements in a workflow may be linked together in any of a variety of ways. For example, one workflow element may be defined to begin only after the completion of another specified workflow element. As another example, one workflow element may be defined to begin only if a particular specified resource is available for use. These and other ways of linking workflow elements to each other are well known to those having ordinary skill in the art. Therefore, the particular examples described herein are merely provided for purposes of illustration and do not constitute limitations of the present invention.

A workflow may be generated in any of a variety of ways. For example, any element(s) of a workflow may be created and/or modified manually by a user of the system 100. For example, a doctor may manually create an appointment element within a workflow to schedule an appointment with a patient. As another example, a doctor may manually reschedule an appointment that was originally scheduled automatically.

As another example, any element(s) of a workflow may be created and/or modified automatically by the system 100, e.g., by the engine 120 as a result of making a prediction and/or recommendation as described herein. For example, if the engine 120 recommends that a particular procedure be performed within an epoch of care, the engine 120 may automatically create an appointment element within a workflow in the model of that epoch of care, indicating that the procedure is to be performed or that the doctor is to determine whether to perform the procedure. As other examples, the engine 120 may automatically modify existing elements within a workflow (whether such elements were originally created automatically or manually), including modifying the dependencies among elements in the workflow.

As another example, the system 100 may include templates of care 142. Each of the templates of care 142 defines a set containing one or more workflows that are applicable to a particular class of EOCs. For example, a particular template of care 142 may be applicable to a particular EOC cohorts 122a. As a result, different templates of care 142 may be applicable to different EOC cohorts. Any one of the templates of care 142 may be created manually or automatically. Furthermore, manually-created templates of care 142 may subsequently be modified either manually or automatically (e.g., based on an EOC model), and automatically-created templates of care 142 may subsequently be modified either manually or automatically.

When a particular EOC model is created, the engine 120 may: (1) identify an EOC cohort for that EOC model, (2) identify zero or more templates of care associated with the identified EOC cohort; and (3) adopt the identified template(s) of care for use with the EOC model. This technique enables the system 100 to learn from past experience by adopting templates of care that have proven useful for a particular EOC cohort without needing to create workflows from scratch each time an EOC model is created.

Furthermore, the system 100 may adapt the templates of care 142 dynamically over time in response to conclusions drawn from data analyzed by the system 100. For example, if a particular template of care associated with a particular EOC cohort is repeatedly modified manually by doctors after it is initially applied automatically by the engine 120 to EOC models falling within that EOC cohort, then the engine 120 may correlate the original template of care and the modified template(s) of care (which may be the same as or differ from each other in various ways) with patient outcomes. If the engine 120 concludes that one or more of the modified templates of care is more strongly correlated with positive patient outcomes than the original template of care, then the engine 120 may replace the original template of care with the best modified template(s) of care, or otherwise modify the original template of care to incorporate features of the best modified template(s) of care that caused them to be highly correlated with positive patient outcomes.

The system 100 may also include role data which defines one or more roles of users of the system 100. For example, the role data may specify that a particular doctor is assigned the role of “lead surgeon” in one workflow and that the same doctor is assigned the role of “consulting surgeon” in another workflow. As this example illustrates, the same user may have different roles in connection with different workflows. As another example, the role data may specify which users have the right to create, access, or modify particular EOC models, workflows, and other data elements in the system 100. The permissions associated with a role may be at any level of granularity, e.g., access to a particular part or functional area of an EOC model, workflow, etc. may be specified.

As the description above illustrates, embodiments of the present invention may be used to improve the provision of personalized healthcare services to patients in a wide variety of ways. One way in which embodiments of the present invention are capable of providing improved healthcare services to an individual patient is by obtaining a combination of any of the data described herein, such as a combination of sensor data (i.e., data obtained from the patient via sensors), profile data (i.e., data obtained about the patient from a source other than a sensor), contextual data (i.e., background information that is not specific to the patient), and epoch of care data for at least one of the patient's epochs of care, and correlating such data to generate a prediction or recommendation that is related to the patient's epoch of care. Generating predictions based on a combination of such data enables embodiments of the present invention to generate predictions/recommendations that are more closely tied to and based on the patient's particular epoch of care than existing systems. In particular, by taking into account the patient's epoch of care data when making predictions/recommendations, embodiments of the present invention can incorporate information from the epoch of care (such as future scheduled procedures) that are not taken into account by existing systems which treat individual events in an epoch of care (such as multiple hospital appointments) as if they were unrelated to each other.

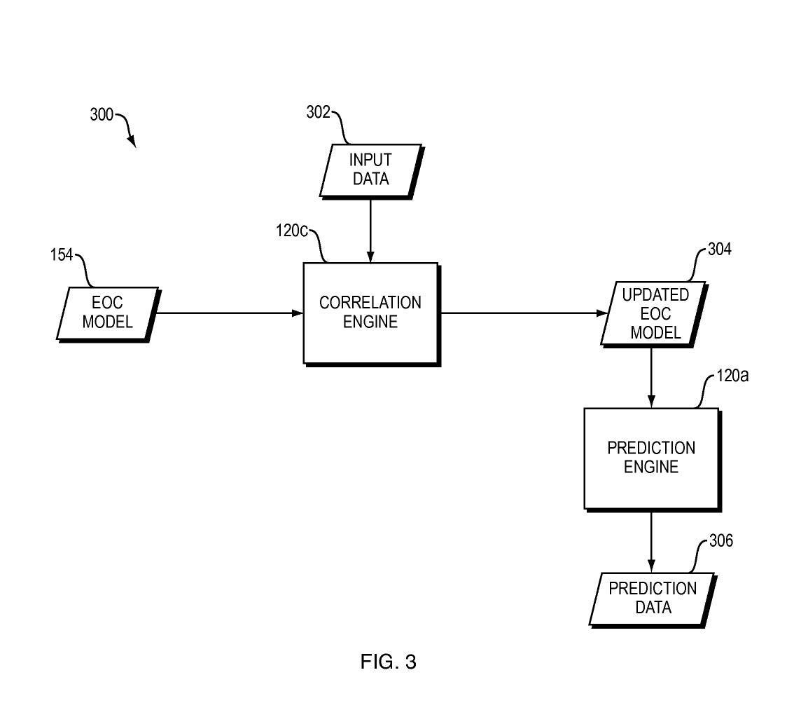

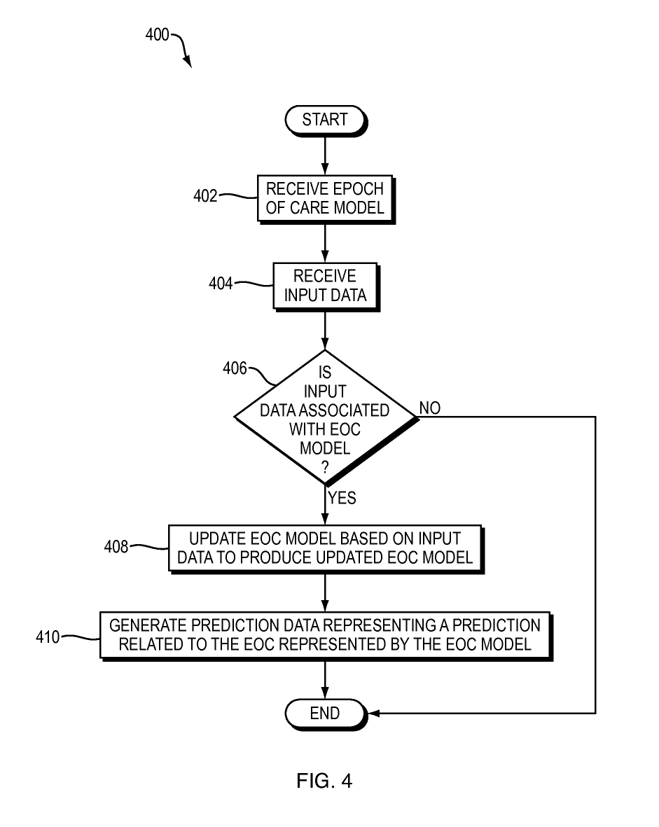

Referring to FIG. 3, a dataflow diagram is shown of a system 300 for correlating data with EOC according to one embodiment of the present invention. Referring to FIG. 4, a flowchart is shown of a method 400 performed by the system 300 of FIG. 3 according to one embodiment of the present invention.

The system 300 includes the correlation engine 120c of FIG. 1E. The correlation engine 120c receives as input the EOC model 154, which represents an epoch of care of a patient (FIG. 4, operation 402). The EOC model 154 may, for example, include data representing a plurality of events within the epoch of care represented by the EOC model 154. The plurality of events may, for example, include a plurality of services (e.g., treatments, diagnoses, prognoses, tests, tasks, or communications) within the epoch of care; a plurality of products (e.g., medications, medical equipment, or implants) used in connection with the epoch of care; a plurality of outcomes (e.g., readmissions, morbidities, measures of patient satisfaction, or symptoms) of the patient within the epoch of care.

The plurality of events may, for example, include a first event associated with a first time (e.g., a first start time and/or end time) and a second event associated with a second time, wherein the first time and the second time differ by any amount of time, such as at least one day, one week, one month, or one year. The first event may, for example, be a first appointment of the patient before a particular procedure within the epoch of care, and the second event may, for example, be a second appointment of the patient after the particular procedure within the epoch of care.

The correlation engine 120c also receives input data 302 as input (FIG. 4, operation 404). The input data 302 may, for example, include any part(s) of the EOC data 150 and/or the external data 152 (FIG. 1A). For example, the input data 302 may include any one or more of the following: contextual data 108a, patient profile data 108b, medical history data 108c, organization data 108d, symptom/disease/syndrome data 108e, and sensor data 108f (e.g., accelerometer data received from an accelerometer, image data received from an image sensor, or audio data received from an audio sensor). As other examples, the input data 302 may include either or both of the template of care data 142 and the workflow data 140. The input data 302 may, for example, be received from or otherwise relate to the patient whose epoch of care is represented by the EOC model 154. The input data 302 may, for example, be received in real-time (e.g., in the case of sensor data 108f received in real-time from one or more sensors).

The correlation engine 120c determines whether the input data 302 is associated with the epoch of care represented by the EOC model 154 (FIG. 4, operation 406). If the correlation engine 120c determines that the input data 302 is associated with the epoch of care represented by the EOC model 154, then the correlation engine 120c updates the EOC model 154 based on the input data 302 to produce an updated EOC model 304 (FIG. 4, operation 408).

The correlation engine 120c may receive data in addition to the input data 302 and then repeat operations 406 and 408 for that additional data. For example, if the input data 302 is the sensor data 108f, then the correlation engine 120c may receive the sensor data 108f and perform operations 406 and 408 on the sensor data 108f. The correlation engine 120c may then receive additional data, such as some or all of the EOC data 136 (FIG. 1C), and perform operations 406 and 408 on the received EOC data 136.

The correlation engine 120 may determine whether the input data 302 is associated with the epoch of care represented by the EOC model 154 in any of a variety of ways. For example, the correlation engine 120 may determine whether the input data 302 is associated with the epoch of care represented by the EOC model 154 based on:
a time associated with the input data 302 and a time associated with the EOC model 154 (such as start times and/or end times);
a person associated with the input data 302 (e.g., the patient from whom the input data 302 is received) and a person associated with the EOC model 154 (e.g., the patient whose EOC is represented by the EOC model 154);
a service (e.g., a test) associated with the input data 302 (e.g., a service during which the input data 302 is received) and a service associated with the EOC model 154;
contextual data associated with the input data 302 and contextual data associated with the EOC model 154; or
workflow data associated with the input data 302 and workflow data associated with the EOC model 154.

The correlation engine 120c may, for example, determine whether the input data 302 is associated with any of a plurality of EOC models. One possible result of making this determination is to determine that the input data 302 is associated with the EOC model 154 (and possibly with additional EOC models). The correlation engine 120c may, for example, determine whether the input data 302 is associated with the EOC represented by the EOC model 154 may performing statistical correlation on the input data 302 and a plurality of EOC models to identify a correlation between the input data 302 and each of the plurality of EOC models. The correlation engine 120c may, for example, determine whether the correlation between the input data 302 and each of the plurality of EOC models satisfies a significance criterion, and determine that the input data 302 is associated with the EOC model 154 only if the correlation between the input data 302 and the EOC model 154 satisfies the significance criterion.

The correlation engine 120c may update the EOC model 154 to produce the updated EOC model 304 in any of a variety of ways, such as by adding the input data 302 or data derived therefrom to the EOC model 154, removing data from the EOC model 154, or replacing data in the EOC model 154 with the input data 302 or data derived therefrom.

The system 300 may also include the prediction engine 120a of FIG. 1E. The prediction engine 120a may generate prediction data 306 representing a prediction related to the epoch of care represented by the EOC model 154 (FIG. 4, operation 410). The prediction engine 120a may, for example, only generate the prediction data 306 if the correlation engine 120c determines (in operation 406) that the input data 302 is associated with the epoch of care represented by the EOC model 154. The prediction engine 120a may, for example, generate the prediction data 306 based on the input data 302, the updated EOC model 304, or both.

Although in the example of FIGS. 3 and 4 the correlation engine 120c updates the EOC model 154 and the prediction engine 120a generates the prediction data 306, this is merely an example and does not constitute a limitation of the present invention. For example, operation 408 may be omitted from the method 300 of FIG. 3, so that the prediction engine 120a generates the prediction data 306 even if the correlation engine 120c does not update the EOC model 154. Conversely, operation 410 may be omitted from the method 300 of FIG. 3, so that the correlation engine 120c updates the EOC model 154 even if the prediction engine 120a does not generate the prediction data 306.

The prediction data 306 may represent a prediction and/or a recommendation. For example, the prediction engine 120a may generate a prediction (based on the input data 302 and/or the updated EOC model 304), and then generate, based on the prediction, a recommendation related to the epoch of care. The prediction data 306 may represent both such a prediction and such a recommendation.

The prediction generated by the prediction engine 120a may, for example, be a prediction of a particular outcome for the patient within the epoch of care. The recommendation generated by the prediction engine 120a may, for example, be a recommendation to perform a particular procedure (e.g., test) on the patient within the epoch of care, to use a particular product within the epoch of care, to schedule a particular appointment for the patient within the epoch of care, to provide a particular communication within the epoch of care, or to utilize a particular resource within the epoch of care.

Embodiments of the present invention have a variety of advantages, such as the following.

Embodiments of the present invention provide the ability to tie together a wide variety of information into a single set of data that represents a particular epoch of care for a particular patient. The ability enables embodiments of the present invention to make predictions and recommendations related to the healthcare services provided within the epoch of care in ways that are more closely tied to the particular characteristics of the epoch of care and which, therefore, are more likely to lead to improved healthcare outcomes for the patient. For example, when recommending that a particular treatment be applied to a patient within an epoch of care, embodiments of the present invention may take into account previous events within the epoch of care and future scheduled events within the epoch of care. In contrast, conventional systems typically treat different events, such as two different hospital visits of the same patient, as unrelated events even if they are part of the same epoch of care. As a result, existing systems are unable to take into account the impact of a future event within a patient's epoch of care on the actions that should be taken in connection with the patient today. In contrast, embodiments of the present invention may take into account not only future events, but also a wide variety of other data, such as sensor data, contextual data, profile data, and outcome data, when making predictions and recommendations in connection with an epoch of care.

In particular, the term “epoch of care,” as used herein, is not limited to a single event (such as a single doctor's visit), a single test, or a single procedure. Rather, a single epoch of care may span multiple events, such as multiple appointments of the same patient in relation to a particular treatment (such as appointments in preparation for a surgery, the surgery itself, and post-surgical appointments). Similarly, a single epoch of care may include multiple tests, multiple resources, multiple staff people, multiple outcomes, and multiple sets of any other kinds of data (such as any one or more of the data 108a-f and 110). Embodiments of the present invention may, therefore, draw conclusions about a single epoch of care based on multiple events taking place over time because of the relation of those events to the same epoch of care. As a result, embodiments of the present invention may draw conclusions that cannot be drawn by conventional systems that are limited to drawing conclusions based on a single event, such as a single test or a single appointment.

More generally, embodiments of the present invention facilitate the practice of evidence-based medicine. In particular embodiments of the present invention facilitate the use of evidence to tailor healthcare services to a patient's particular epoch of care. As a result, embodiments of the present invention enable healthcare services to be provided more efficiently, where such increased efficiency may include an increase in quality, a decrease in cost, or both an increase in quality and a decrease in cost. For example, embodiments of the present invention may be used to increase the quality of healthcare services by enabling treatments to be selected and tailored to the patient based on the patient's particular epoch of care, thereby increasing the likelihood that such treatments will have positive effects in connection with the epoch of care. Embodiments of the present invention may be used to decrease the cost of healthcare services by selecting targeted treatments, and avoiding other treatments, either automatically or with a reduced amount of experimentation (e.g., in the form of tests that do not produce useful results) than traditional medical techniques.

Embodiments of the present invention also assist in creating better coordination of care, more intelligent workflows, higher quality of care, and more efficient care generally. Embodiments of the present invention are able to achieve these results in a variety of ways. For example, embodiments of the present invention may, when making predictions and/or recommendations for care, take into account factors such as the delivery system via which the care is delivered, operational constraints, and resource constraints, all within the context of the patient's particular epoch of care. Furthermore, embodiments of the present invention may take into account the load that the patient's epoch of care imposes on resources within the system at a particular point in time (e.g., during holidays or at certain times of day). As a particular example, consider a disaster in which a large number of incoming patients with serious injuries are admitted to a hospital in a short period of time. Embodiments of the present invention may take this load into account when predicting and recommending treatments to apply to any particular patient at that hospital during the disaster, in light of the load and the patient's epoch of care.

As another particular example, consider an outbreak of influenza which causes ten nurses at a particular hospital to become sick, thereby reducing the number of nurses who are available to be assigned to patients. Embodiments of the present invention may take such limited availability of particular classes (i.e., roles) of hospital staff into account when recommending treatments to be performed on particular patients and the staff to be assigned to those treatments in light of the patients' epochs of care.

As yet another example, embodiments of the present invention may adapt workflows in an epoch of care based on constraints at a particular time, such as constraints on labor that may be assigned to the epoch of care, capital that may be expended in connection with the epoch of care, and the volume of resources that may be assigned to the epoch of care. A particular appointment within a workflow may, for example, be delayed to a later date if resources required for the workflow are unavailable or prohibitively expensive to assign to the workflow on the originally-scheduled dated, and if delaying the appointment is not predicted to have a substantial negative impact on the patient, in light of the patient's epoch of care.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

For example, any of the data disclosed herein as being contained within a particular module or other data may additionally or alternatively be stored elsewhere. For example, data shown as contained within the external data 134 in FIG. 1C may additionally or alternatively be stored within the EOC data 136. Conversely, data shown as contained within the EOC data 136 may additionally or alternatively be stored within the external data 134. As a particular example, some or all of the patient profile data 108b, which is shown in FIG. 1C as being stored within the EOC data 136, may additionally or alternatively be stored in the external data 134.

Any of the functions disclosed herein may be implemented using means for performing those functions. Such means include, but are not limited to, any of the components disclosed herein, such as the computer-related components described below.

Although EOC models (such as the EOC model 154) may be described herein as containing various data, any data described herein as being contained within an EOC model may additionally or alternatively be stored outside of the EOC model and be referenced by the EOC model. Conversely, any data described herein as being stored outside of an EOC model may additionally or alternatively by stored within the EOC model.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

1. A method performed by at least one computer processor executing computer program instructions stored on at least one non-transitory computer-readable medium, the method comprising:
(A) receiving sensor data from a patient via a sensor;
(B) determining whether the sensor data is associated with an epoch of care model representing an epoch of care of the patient, wherein the epoch of care model includes data representing a plurality of events within the epoch of care, and wherein the epoch of care model data includes data identifying the patient; and
(C) if the sensor data is determined to be associated with the epoch of care model, then updating the epoch of care model based on the sensor data.

2. The method of claim 1, further comprising:
(D) receiving epoch of care data, wherein the epoch of care data does not include the sensor data;
(E) determining whether the epoch of care data is associated with the epoch of care model representing the epoch of care of the patient; and
(F) if the epoch of care data is determined to be associated with the epoch of care model, then updating the epoch of care model based on the epoch of care data.

3. The method of claim 2, wherein (E) comprises determining whether the epoch of care data is associated with the epoch of care model based on a time associated with the epoch of care data and a time associated with the epoch of care model.

4. The method of claim 2, wherein (E) comprises determining whether the epoch of care data is associated with the epoch of care model based on a person associated with the epoch of care data and a person associated with the epoch of care model.

5. The method of claim 2, wherein (E) comprises determining whether the epoch of care data is associated with the epoch of care model based on a service associated with the epoch of care data and a service associated with the epoch of care model.

6. The method of claim 2, wherein (E) comprises determining whether the epoch of care data is associated with the epoch of care model based on contextual data associated with the epoch of care data and contextual data associated with the epoch of care model.

7. The method of claim 2, further comprising:
(G) updating the epoch of care model based on the epoch of care data.

8. The method of claim 1, wherein the sensor data comprises accelerometer data, and wherein (A) comprises receiving the accelerometer data from an accelerometer in real-time.

9. The method of claim 1, wherein the sensor data comprises image data, and wherein (A) comprises receiving the image data from an image sensor in real-time.

10. The method of claim 1, wherein the sensor data comprises audio data, and wherein (A) comprises receiving the audio data from an audio sensor in real-time.

11. The method of claim 1, wherein the data representing the plurality of events within the epoch of care comprises data representing a plurality of services within the epoch of care.

12. The method of claim 1, wherein the data representing the plurality of events comprises data representing a plurality of products used in connection with the epoch of care.

13. The method of claim 1, wherein the data representing the plurality of events comprises data representing a plurality of outcomes of the patient within the epoch of care.

14. The method of claim 1, wherein the data representing the plurality of events within the epoch of care comprises data representing a first event associated with a first time and data representing a second event associated with a second time, wherein the first time and the second time differ by at least one day.

15. The method of claim 14, wherein the first event comprises a first appointment of the patient before a particular procedure within the epoch of care and wherein the second event comprises a second appointment of the patient after the particular procedure within the epoch of care.

16. The method of claim 1, wherein (B) comprises determining whether the sensor data is associated with the epoch of care model based on a time associated with the sensor data and a time associated with the epoch of care model.

17. The method of claim 1, wherein (B) comprises determining whether the sensor data is associated with the epoch of care model based on a person associated with the sensor data and a person associated with the epoch of care model.

18. The method of claim 1, wherein (B) comprises determining whether the sensor data is associated with the epoch of care model based on a service associated with the sensor data and a service associated with the epoch of care model.

19. The method of claim 1, wherein (B) comprises determining whether the sensor data is associated with any of a plurality of epoch of care models.

20. The method of claim 19, wherein (B) comprises:
(B) (1) performing statistical correlation on the sensor data and the plurality of epoch of care models to identify a correlation between the sensor data and each of the plurality of epoch of care models.

21. The method of claim 1, further comprising
(D) if the sensor data is determined to be associated with the epoch of care model, then generating a prediction related to the epoch of care based on the sensor data.

22. The method of claim 1, wherein (C) comprises adding data derived from the sensor data to the epoch of care model.

23. The method of claim 1, wherein (C) comprises replacing data in the epoch of care model with data derived from the sensor data.

24. A system comprising at least one computer-readable medium containing computer program instructions, wherein the computer program instructions are executable by at least one computer processor to perform a method, the method comprising:
(A) receiving sensor data from a patient via a sensor;
(B) determining whether the sensor data is associated with an epoch of care model representing an epoch of care of the patient, wherein the epoch of care model includes data representing a plurality of events within the epoch of care, and wherein the epoch of care model data includes data identifying the patient; and
(C) if the sensor data is determined to be associated with the epoch of care model, then updating the epoch of care model based on the sensor data.

25. A method performed by at least one computer processor executing computer program instructions stored on at least one non-transitory computer-readable medium, the method comprising:
(A) receiving sensor data from a patient via a sensor;
(B) determining whether the sensor data is associated with an epoch of care model representing an epoch of care of the patient, wherein the epoch of care model includes data representing a plurality of events within the epoch of care, and wherein the epoch of care model data includes data identifying the patient; and
(C) if the sensor data is determined to be associated with the epoch of care model, then generating a prediction related to the epoch of care based on the sensor data.

26. The method of claim 25, further comprising:
(D) generating a recommendation related to the epoch of care based on the prediction.

27. The method of claim 26, wherein (D) comprises generating a recommendation to schedule a particular appointment for the patient within the epoch of care.

28. The method of claim 25, wherein (C) comprises generating a prediction of a particular outcome for the patient within the epoch of care.

29. The method of claim 25, further comprising:
(D) updating the epoch of care model based on the prediction or recommendation.

30. A system comprising at least one computer-readable medium containing computer program instructions, wherein the computer program instructions are executable by at least one computer processor to perform a method, the method comprising:
(A) receiving sensor data from a patient via a sensor;
(B) determining whether the sensor data is associated with an epoch of care model representing an epoch of care of the patient, wherein the epoch of care model includes data representing a plurality of events within the epoch of care, and wherein the epoch of care model data includes data identifying the patient; and
(C) if the sensor data is determined to be associated with the epoch of care model, then updating the epoch of care model based on the sensor data.
